(19) United States
(12) Patent Application Publication
(10) Pub. No.: US 2009/0292055 A1
(43) Pub. Date: Nov. 26, 2009

(54) NANOCOMPOSITES COMPLIANT WITH REGULATORY REQUIREMENTS

(75) Inventors: David A. Jarus, Avon Lake, OH (US); Guoqiang Qian, Arlington Heights, IL (US)

Correspondence Address: POLYONE CORPORATION, 33587 WALKER ROAD, AVON LAKE, OH, 44012, US

(73) Assignees: POLYONE CORPORATION, Avon Lake, OH (US); AMCOL INTERNATIONAL CORPORATION, Arlington Heights, IL (US)

(21) Appl. No.: 12/295,537

(22) PCT Filed: Mar. 27, 2007
(86) PCT No.: PCT/US07/64996

§ 371 Date: Sep. 30, 2008

Related U.S. Application Data
(60) Provisional application No. 60/744,611, filed on Apr. 11, 2006.

(51) Int. Cl. C08K 3/34

(52) U.S. Cl. 524/445

(57) ABSTRACT

A nanocomposite is made from melt-mixing of polyethylene with organoclay in the presence of a maleated polypropylene. Unexpectedly, the maleated polypropylene and polyethylene are sufficiently compatible to permit excellent dispersion of the organoclay in the nanocomposite. Because maleated polypropylene is compliant with U.S. Food and Drug Administration regulations, though maleated polyethylene is not, one can use nanocomposites of the present invention for articles to be in contact with human food.

### CLAIM OF PRIORITY

This application claims priority from U.S. Provisional Patent Application Ser. No. 60/744,611 bearing Attorney Docket Number 12006006 and filed on Apr. 11, 2006, which is incorporated by reference.

### FIELD OF THE INVENTION

This invention concerns composites of polyolefins which contain organoclay dispersed therein because of certain compatibilizers.

### BACKGROUND OF THE INVENTION

The mixture of organoclays and polyolefins, commonly called nano-olefins, is highly desired because the organoclays can contribute stiffness and toughness properties to polyolefins for extruded or molded articles. Polyolefins for molded or extruded articles have been useful since the mid-20^{th} Century. Organoclays, smectite inorganic clays intercalated with organic ions, such as quaternary ammonium, have become useful in the last decade.

Organoclays are expensive additives for polyolefins such as polypropylene (PP). Nonetheless, several others have taught the use of organoclays as additives for PP, among other resins. Representative examples of such prior work include U.S. Pat. No. 6,462,122 (Qian et al.) and PCT Published Patent Application WO 2005/056644 (Jarus et al.). All of these prior efforts provide organoclay in a generalized listing of PP compounds.

When used packaging, particularly food packaging such as films, each of the ingredients need to be listed in the USA Title 21 of the Code of Federal Regulations, which is regulated by the United States Food and Drug Administration (FDA).

### SUMMARY OF THE INVENTION

What the art needs is a polyethylene nanocomposite that is FDA compliant. “FDA compliant” means that each of the ingredients of the polyolefin nanocomposites of the invention are listed in 21 CFR as generally regarded as safe (“GRAS”) for food contact applications.

The present invention solves the problem by using a polypropylene-based compatibilizer with a mixture of organoclay and a polyethylene resin matrix. More particularly, the polypropylene-based compatibilizer is a maleated polypropylene also used in the inventions disclosed in U.S. Pat. No. 6,462,122 (Qian et al.) and PCT Published Patent Application WO 2005/056644 (Jarus et al.)

Unexpectedly, it has been found that even though a maleated polypropylene (“PP-g-MAH”) is considered by those of ordinary skilled in the art to be immiscible with polyethylene (“PE”), the PP-g-MAH provides acceptable compatibility for dispersing the organoclay into the PE matrix.

The unexpected compatibility (in spite of apparent immiscibility) of PP-g-MAH with PE means that a nanoconcentrate (highly concentrated organoclay in thermoplastic matrix) can be blended with adequate organoclay dispersion and with FDA compliant ingredients.

One skilled in the art would have reached a blockage that is caused by trying to make a nanoconcentrate with a PE matrix and a maleated polyethylene (PE-g-MAH) as a compatibilizer. PE-g-MAH is not FDA compliant.

Thus, one aspect of this invention is a composite comprising: (a) organoclay; (b) polyethylene matrix; and (e) maleated polypropylene to assist dispersion of the organoclay in the polyethylene matrix.

Another aspect of the present invention is a concentrate of the composite, wherein the organoclay comprises at least about 10 weight percent of the total composition.

Another aspect of the present invention is a compound of the composite, wherein the organoclay comprises at least about 0.1 weight percent of the total composition.

Another aspect of the present invention is a film made from the compound.

Features and advantages of the invention will be explained below while discussing the embodiments.

### EMBODIMENTS OF THE INVENTION

Polyethylene

“Polyethylene” includes homopolymers, copolymers, blends of polymers, mixtures of polymers, alloys of polymers, and combinations thereof where at least one of the polymers is polymerized from an olefin monomer having 2 carbon atoms.

Non-limiting examples of polyethylenes suitable for the present invention include low-density (LDPE), high-density, high molecular weight (HDPE), ultra-high molecular weight (UHMWPE), linear-low-density (LLDPE), very-low density (VLDPE), and mixtures, blends or alloys thereof.

Polyethylenes useful in the present invention can have a melt flow index ranging from about 0.1 to about 100, and preferably from about 2 to about 40.

Particularly preferred is LLDPE because of its suitability for FDA compliant food packaging.

Commercial sources of polyethylenes include multinational companies such as Dow Chemical, ExxonMobil, and others.

Organoclays

Organoclay is obtained from inorganic clay from the smectite family. Smectites have a unique morphology, featuring one dimension in the nanometer range. Montmorillonite clay is the most common member of the smectite clay family. The montmorillonite clay particle is often called a platelet, meaning a sheet-like structure where the dimensions in two directions far exceed the particle's thickness.

Inorganic clay becomes commercially significant if intercalated with an organic intercalant to become an organoclay. An intercalate is a clay-chemical complex wherein the clay gallery spacing has increased, due to the process of surface modification by an intercalant. Under the proper conditions of temperature and shear, an intercalate is capable of exfoliating in a resin matrix, such as LLDPE or other polyethylenes. An intercalant is an organic or semi-organic chemical capable of entering the montmorillonite clay gallery and bonding to the surface. Exfoliation describes a dispersion of an organoclay (surface treated inorganic clay) in a plastic matrix. In this invention, organoclay is exfoliated at least to some extent.

In exfoliated form, organoclay platelets have a flexible sheet-type structure which is remarkable for its very small size, especially the thickness of the sheet. The length and breadth of the particles range from 1.5 μm down to a few tenths of a micrometer. However, the thickness is astoundingly small, measuring only about a nanometer (a billionth of a meter). These dimensions result in extremely high average aspect ratios (200-500). Moreover, the miniscule size and thickness mean that a single gram contains over a million individual particles.

Nanocomposites are the combination of the organoclay and the plastic matrix. In polymer compounding, a nanocomposite is a very convenient means of delivery of the organoclay into the ultimate compound, provided that the plastic matrix is compatible with the principal polymer resin components of the compounds. In such manner, nanocomposites are available in concentrates, masterbatches, and compounds from Nanocor, Inc. of Arlington Heights, Ill. (www.nanocor.com) and PolyOne Corporation of Avon Lake, Ohio (www.polyone.com) in a variety of nanocomposites. Particularly preferred organoclays are 124TL, 130P, and I44P from Nanocor, Inc.

Nanocomposites offer flame-retardancy properties because such nanocomposite formulations burn at a noticeably reduced burning rate and a hard char forms on the surface. They also exhibit minimum. dripping and fire sparkling.

Compatibilizer

As stated above, the compatibilizer is based on polypropylene, not polyethylene. Maleated polypropylene is identified in U.S. Pat. No. 6,462,122 (Qian et al.) and PCT Published Patent Application WO 2005/056644 (Jarus et al.) to provide compatibility between organoclay and polypropylene. This invention uses the same compatibilizers with polyethylene, normally considered to be an immiscible combination.

Maleated polypropylene (PP-g-MAH) is also identified as maleic anhydride grafted polypropylene.

Commercial sources of PP-g-MAH include maleated PP from Chemtura Corporation bearing the Polybond brand in various grades, such as 3000, 3002, 3150, 3200, and X5104 and from Shanghai World-Prospect Industrial Co., Ltd. To be FDA compliant under 21 CFR §175.300(b)(3)(ix), PP-g-MAH currently needs to have a maleic anhydride content of less than 0.8 percent. Polybond grades 3002 and 3150 satisfy that requirement, and it is possible that the final specifications of developmental grade X5104 will also comply.

Optional Additives

The nanocomposite of the present invention can include conventional plastics additives in an amount that is sufficient to obtain a desired processing or performance property for the ultimate thermoplastic compound, but in a manner that does not disrupt the melt flow performance properties and compliance with FDA regulations as GRAS under 21 Code of Federal Regulations.

The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.williamandrew.com), can select from many different types of additives for inclusion into the nanocomposites of the present invention.

Non-limiting examples of optional additives include adhesion promoters; FDA compliant biocides, if any, (antibacterials, fungicides, and mildewcides), anti-fogging agents; anti-static agents; bonding, blowing and foaming agents; dispersants; fillers and extenders; FDA compliant fire and flame retardants and smoke suppressants, if any; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; and combinations of them.

Optional Polymers

While the nanocomposite can be made without other polymers present, it is optional to introduce other polymers into the extruder for a variety of ultimate compound properties and performances, but in a manner that does not disrupt the stiffness, toughness, and melt flow performance property of the nanocomposite. These materials can be blended, co-extruded, or otherwise laminated with the for composite structures. Other resins include those selected from the group consisting of polyolefins, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK) and mixtures thereof.

Table 1 shows ranges of acceptable, desirable, and preferred weight percents of the various ingredients for addition to the extruder, relative to the total weight of the nanocomposite emerging from the extruder, all being expressed as approximate values. Because the additives and other polymers are optional, the low end of each range is zero.

TABLE 1
Weight Percent of Ingredients

| | Acceptable | Desirable | Preferred |
|---|---|---|---|
| Ingredients | (Wt. %) | (Wt. %) | (Wt. %) |
| PE Resin | 10-99 | 30-95 | 50-90 |
| Organoclay | 0.1-70 | 0.5-20 | 1-10 |
| PP-g-MAH | 0.1-70 | 0.5-20 | 1-10 |
| Optional Additives | 0-70 | 0-50 | 0-30 |
| Optional Polymers | 0-90 | 0-65 | 0-50 |

Processing

The preparation of compounds of the present invention is uncomplicated. The compound of the present can be made in batch or continuous operations. The compound can start from a concentrate of organoclay in a thermoplastic (also called a masterbatch) or original ingredients.

Mixing occurs in an extruder or a continuous mixer that is elevated to a temperature that is sufficient to melt the polyethylene and disperse the organoclay with the aid of the PP-g-MAH compatibilizer, and any optional other polymers and to adequate disperse the organoclay and optional additives therewithin.

Extruders have a variety of screw configurations, including but not limited to single and double, and within double, co-rotating and counter-rotating. Extruders also include kneaders and continuous mixers, both of which use screw configurations suitable for mixing by those skilled in the art without undue experimentation. In the present invention, it is preferred for chain extension to use a twin co-rotating screw in an extruder commercially available from Coperion Werner-Pfleiderer GmbH of Stuttgart, Germany.

Continuous mixers include Farrel Continuous Mixers (FCM) from Farrel Corporation of Ansonia, Conn., USA. The temperature useful in the FCM can be about 230° C. before the mixer delivers pelletized concentrate or compounds.

Extruders have a variety of heating zones and other processing parameters that interact with the elements of the screw(s). Extruders can have temperatures and other conditions according to acceptable, desirable, and preferable ranges as shown in Table 2.

TABLE 2
Processing Conditions

| Condition | Acceptable | Desirable | Preferred |
|---|---|---|---|
| Zones 1-5 Temp. | 170° C.-230° C. | 180° C.-220° C. | 190° C. |
| Zones 6-7 Temp. | 180° C.-240° C. | 180° C.-230° C. | 200° C. |
| Zones 8-9 Temp. | 190° C.-240° C. | 190° C.-230° C. | 200° C. |
| Die Temp. | 190° C.-240° C. | 190° C.-230° C. | 200° C. |
| Screw Rotation | 300-1100 rpm | 400-1000 rpm | 600 rpm |
| Feeder Rate | 50-95% of | 75-95% of | 90-95% of |
| | available | available | available |
| | drive torque | drive torque | drive torque |

Location of ingredient addition into the extruder can be varied according the desired duration of dwell time in the extruder for the particular ingredient. Table 3 shows acceptable zones when ingredients are to be added in the process of the present invention.

TABLE 3
Ingredient Addition Points

| Ingredient | Acceptable Zone(s) |
|---|---|
| PE Resin | Throat |
| Organoclay | Throat |
| PP-g-MAH | Throat |
| Optional Additives | Throat |
| Optional Polymers | Throat or Downstream or Both |

Extruder speeds can range from about 50 to about 1200 revolutions per minute (rpm), and preferably from about 300 to about 600 rpm.

Typically, the output from the extruder is pelletized for later extrusion or molding into polymeric articles.

Subsequent Processing

The nanocomposite made according to the present invention can serve either as a concentrate or as a compound. If the former, then the nanocomposite is an intermediate product, an ingredient to be added with other ingredients to subsequent compounding steps in a batch or continuous mixing apparatus. The dilution or “let-down” of the concentrate into the compound can result in an organoclay concentration in the compound ranging from about 4 to less than 15 weight percent, and preferably from about 6 to about 12 weight percent, to maximize stiffness and toughness performance properties with minimal concentration of organoclay in the nanocomposite.

Ultimately, the compound is formed into an article or film using a subsequent extrusion or molding techniques. These techniques are well known to those skilled in the art of thermoplastics polymer engineering. Without undue experimentation but using references such as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one can make articles of any conceivable shape and appearance using nanocomposites of the present invention.

### USEFULNESS OF THE INVENTION

Nanocomposites of the present invention are useful for making complex curved molded articles, simple curved extruded articles, and the like. Any of the articles of the present invention can be made to have a particular color by use of color concentrates from PolyOne Corporation. Thus, conventional PE articles can have the addition of FDA compliance and the advantages of organoclay, stiffness, toughness, barrier properties, etc.

Further embodiments of the invention are described in the following Examples.

### EXAMPLES

Table 4 shows concentrate formulations of Comparative Example A and Example 1 and the results of dispersion of mixing in a Farrell Continuous Mixer operating at about 232° C.

The concentrates were pelletized and then molded into tensile test bars and other plaques. The plaques were analyzed for dispersion using x-ray diffraction and an optical microscope by persons familiar with gradations of organoclay dispersion in thermoplastics.

TABLE 4
Concentrate Formulations and Results
(Wt. Percent)

| | A | 1 |
|---|---|---|
| LLDPE polymer (50 melt flow index) | 24.8 | 24.8 |
| I44P clay (Nanocor) | 60 | 60 |
| Polybond X5104 maleated PP (Chemtura) | 0 | 15 |
| Polybond 3109 maleated PE (Chemtura) | 15 | 0 |
| Antioxidant (Ultranox 1010) | 0.2 | 0.2 |
| FDA Compliant | No | Yes* |
| Dispersion | Excellent | Excellent |

*Polybond X5104 can be FDA compliant, depending on final specifications of that developmental material. If not, then another grade Polybond PP-g-MAH that is FDA compliant, such as Polybond 3002 or Polybond 3150, can be used.

The invention is not limited to the above embodiments. The claims follow.

What is claimed is:

1. A composite comprising:
(a) organoclay;
(b) polyethylene matrix; and
(c) maleated polypropylene to assist dispersion of the organoclay in the polyethylene matrix.

2. A concentrate of the composite of claim 1, wherein the organoclay comprises at least about 10 weight percent of the total composition.

3. A compound of the composite of claim 1, wherein the organoclay comprises at least about 0.1 weight percent of the total composition.

4. The composite of any of claim 1, wherein polyethylene comprises any of homopolymers, copolymers, blends of polymers, mixtures of polymers, alloys of polymers, and combinations thereof, where at least one of the polymers is polymerized from an olefin monomer having 2 carbon atoms.

5. The composite of claim 4, wherein the polyethylene comprises low-density polyethylene, high-density, high molecular weight polyethylene, ultra-high molecular weight polyethylene, linear-low-density polyethylene, very low density polyethylene, and mixtures, blends or alloys thereof and wherein the polyethylene has a melt flow index of from about 0.1 to about 100.

6. The composite of claim 1, wherein the organoclay is montmorillonite clay intercalated with an organic or semi-organic chemical.

7. The composite of claim 1, wherein the compatibilizer is maleic anhydride grafted polypropylene having a maleic anhydride content of less than 0.8 percent.

8. The composite of claim 1, wherein the composite further includes optional additives.

9. The composite of claim 1, wherein the composite further includes optional polymers.

10. The composite of claim 1, wherein the organoclay comprises from about 0.1 to about 70 weight percent of the composite.

11. The composite of claim 1, wherein the compatibilizer comprises from about 0.1 to about 79 weight percent of the composite.

12. The composite of claim 10, wherein the organoclay comprises from about 1 to about 10 weight percent of the compound and wherein the compatibilizer comprises from about 1 to about 10 weight percent of the compound.

13. A film made from the compound of claim 3, wherein the film is made from ingredients that are listed in Title 21 of United States Code of Federal Regulations as generally regarded as safe (“GRAS”) for food contact applications.

14. An article made from the composite of claim 1, wherein the article is a simple curved extruded article or a complex curved molded article.

15. The compound of claim 3, wherein polyethylene comprises any of homopolymers, copolymers, blends of polymers, mixtures of polymers, alloys of polymers, and combinations thereof, where at least one of the polymers is polymerized from an olefin monomer having 2 carbon atoms.

16. The compound of claim 3, wherein the organoclay is montnorilonite clay intercalated with an organic or semi-organic chemical.

17. The compound of claim 3, wherein the compatibilizer is maleic anhydride grafted polypropylene having a maleic anhydride content of less than 0.8 percent.

18. The compound of claim 3, wherein the organoclay comprises from about 1 to about 10 weight percent of the compound and wherein the compatibilizer comprises from about 1 to about 10 weight percent of the compound.

19. The concentrate of claim 2, wherein polyethylene comprises any of homopolymers, copolymers, blends of polymers, mixtures of polymers, alloys of polymers, and combinations thereof where at least one of the polymers is polymerized from an olefin monomer having 2 carbon atoms.

20. The concentrate of claim 2, wherein the organoclay is montmorillonite clay intercalated with an organic or semi-organic chemical and wherein the compatibilizer is maleic anhydride grafted polypropylene having a maleic anhydride content of less than 0.8 percent.
